(19) United States
(12) Patent Application Publication
(10) Pub. No.: US 2010/0132659 A1
(43) Pub. Date: Jun. 3, 2010

(54) CAT AND MOUSE TYPE MACHINE WITH MULTI-PURPOSE PORTS

(76) Inventor: Vishvas Prabhakar Ambardekar, Maharashtra (IN)

Correspondence Address: Ambardekar Vishvas;Snehal Apartments, Flat No. 1, Plot No. B-82, Tulshibagwale Colony, Sharkar Nagar No.2, Pune, 411009, IN

(21) Appl. No.: 12/452,422

(22) PCT Filed: Jul. 3, 2007
(86) PCT No.: PCT/IN2007/000276

§ 371 Date: Dec. 30, 2009

(51) Int. Cl. F02B 53/00

(52) U.S. Cl. 123/245

(57) ABSTRACT

In a revolving piston device that is used to make a four stroke internal combustion engine, revolving piston pairs (22, 23, 24, 25) are made to complete two cycles of one compression phase and one expansion phase each. The openings (2-7, 10-17, 34-36) on components of revolving piston device are made in such a way that an opening can be used for multiple flow passages to reduce unutilised space within controlled active volume that reduces unutilised expansion of gases or air within controlled active volume during respective power stroke. This also reduces loss of fresh gases trapped within the openings to exhaust manifold. This invention describes how to use same opening on various components of a revolving piston device for multiple flow passages to reduce overall losses.

### BACKGROUND

A revolving piston internal combustion engine without a reciprocating component is described in international patent application PCT/IN03/00025, titled “Revolving Piston Internal Combustion Engine” that suggests a mechanism with two elliptical gears in mesh or a double crank mechanism with some positive drive train, for controlling variation in relative speed of the two revolving assemblies. Subsequently to reduce speed of revolving components of relative speed profile generator, a concept of “port operating ring” was introduced in another international patent application PCT/IN06/00321 dated Aug. 24, 2006, bearing title “Modified, Revolving Piston Internal Combustion Engine”.

Present invention is concerned with reduction in size and number of openings or reduction in total volume of openings on a component, adjacent to revolving piston pair, of a revolving piston device. As an example for present revolving piston device, the component adjacent to revolving piston pair is taken as fixed circular ring in which piston pairs revolve. For other configurations of revolving piston devices, a port operating ring can be placed between piston pairs and openings on fixed circular ring. Reduction in size or volume of openings helps in reducing unutilised expansion of gases during power stroke and loss of unused air or gases through exhaust, while using a revolving piston device as an internal combustion engine.

The reduction in volume of openings is achieved by utilising an opening on a component for different flow passages, i.e. instead of providing separate openings for intake and exhaust flow passages; same opening on a component of revolving piston device is used for intake flow passage for some time and for exhaust flow passage for some other time. This also helps in reducing the size of port operating ring.

### INTRODUCTION

International patent application PCT/IN06/00321, has described a revolving piston device that is used as an internal combustion engine and had separate openings on fixed circular ring for intake and exhaust flow passages respectively. Separate openings increases volume of unutilised openings exposed to a controlled active volume, for example, an opening for intake flow passage and an opening for exhaust flow passage will not be used during exhaust stroke and during intake stroke respectively; space within these openings will also remain unutilised during respective strokes. Further air or gases trapped within these openings may escape unutilised with exhaust gases; similarly during power stroke, expansion of gases within these openings does not produce any power. Separate openings for intake and exhaust flow passages on a port operating ring makes it bulky, though it allows use of two separate port operating rings for intake and exhaust flow passages respectively. A way to reduce volume of openings on the component adjacent to revolving pistons of a revolving piston device is described here.

In present invention multi-purpose openings are designed that are located on a component adjacent to the revolving piston pair, i.e. for present revolving piston device on fixed circular ring, corresponding multi-purpose openings are also located on port operating ring, and are used for multiple flow passages, for example same opening is used for intake as well as for exhaust flow passages for different time intervals. This reduces volume of unutilised openings on a component adjacent to piston pairs i.e. for present case, a fixed circular ring. This also makes a port operating ring more compact. Volume of unutilised openings can also be reduced further by use of appropriate valves for closing and opening of an opening, as part of the valve that enters an opening can partially fill the space within the opening thus without changing size of an opening, volume trapped within an opening can be reduced. A transfer passage is also designed on port operating ring to allow gases or air to flow from pre-compression chamber to a controlled active volume during its intake stroke thus supplying pre-compressed air or air fuel mixture or gases to a controlled active volume during its intake stroke.

Basic design of the revolving piston device inclusive of linkage for relative speed profile generator is similar to that explained in the international patent applications PCT/IN03/00025 and PCT/IN06/00321, thus not discussed here in detail.

Same methodology as discussed further can be used to design a revolving piston device with one or more number of revolving piston pairs associated with a fixed circular ring, for that appropriate speed ratio between revolving pistons and respective revolving members of relative speed profile generator should be selected, accordingly suitable speed ratio between respective revolving pistons and port operating ring should be decided. This type of revolving piston devices can be used for making internal combustion engines for different types of fuels, also for making external combustion engines and also for making engines that can work on compressed air. These types of engines can be used in automobiles, electric power generation, aero industries, marine ships, battlefield tanks, and in many other applications. With appropriate considerations at design stage and using facility to modify compression ratio, a multi fuel engine and a variable compression ratio engine can also be designed with same concept. With appropriate design changes, same concept can also be used to develop a revolving piston air compressor.

### DEFINITIONS

Controlled Active Volume (CAV): In the direction of rotation of revolving pistons, volume trapped from trailing piston to leading piston of a revolving piston pair, is called controlled active volume. In other words volume trapped between pistons of a revolving piston pair is called controlled active volume. While pistons revolve, variation in relative speed of pistons of a revolving piston pair causes variation in CAV that causes expansion and compression of CAV, which is appropriately utilised for various strokes of an internal combustion engine or a compressor.

Pre-compression chamber: Pre-compression chamber is the space trapped in direction of revolution from leading piston to trailing piston of a piston pair for a revolving piston device with single revolving piston pair, and is the space trapped between one piston of a piston pair and adjacent piston of another piston pair for a revolving piston device with more revolving piston pairs. Thus a revolving piston has CAV on one side of it and pre-compression chamber on other side of it. During a compression phase of CAV, pre-compression chamber undergoes expansion, and air or gases can be sucked into it from intake manifold. During expansion phase of CAV, contents of pre-compression chamber undergo compression and can be forced into a CAV that undergoes its intake stroke. For a revolving piston device with two or more pre-compression chambers, few or all of them are inter-connected as to have free flow of gases within interconnected pre-compression chambers.

TDC and BDC equivalent: During revolutions of revolving pistons, when pistons of a revolving piston pair are closest to each other and respective CAV is at its minimum, they are called to be at TDC equivalent. Similarly when pistons of a revolving piston pair are farthest to each other and respective CAV is at its maximum, they are said to be at BDC equivalent. Thus an expansion phase of a CAV is experienced from its TDC equivalent to its BDC equivalent and a compression phase of a CAV is experienced from its BDC equivalent to its TDC equivalent.

Openings and passages on a component: The purpose of an opening or a passage on a component is to provide a path for air or gases to flow from one place to another place on the component. If the path for flow of air or gases is through a channel provided on a component, then the path is termed as a passage on the component and if it is straight through the component then the path is termed as an opening on the component. As the purpose of an opening and a passage on a component is same, either of the terms “opening” and “passage”, in relation to a component, can be used in place of each other. Hereafter term “opening” is used both, for a passage and for an opening, on a component. One of the openings on port operating ring is termed as transfer passage to improve readability of text. The term “flow passage” is used for a path for flow of air or gases through more than one component.

### NOMENCLATURE FOR DRAWING SHEETS

FIG. 1 to FIG. 7 shows schematic representation of a revolving piston device and its few major components. Sequentially and schematically, FIG. 8 to FIG. 15 show few important states of revolving piston pairs along with corresponding positions of openings on port operating ring, during the two cycles of CAV consisting of one expansion phase and one compression phase each, for a revolving piston device as shown in FIG. 1, which is used as a four stroke internal combustion engine.

FIG. 1: Schematic representation of present revolving piston device, with revolving piston pairs at their TDC equivalent, which is used for explaining the invention.

FIG. 2: Schematic sectional view at A-A of the revolving piston device as shown in FIG. 1, with fixed circular ring shown partially.

FIG. 3: Schematic representation of openings on fixed circular ring.

FIG. 4: Schematic representation of openings, on a fixed component, for intake and exhaust manifolds.

FIG. 5: Schematic representation of openings on port operating ring.

FIG. 6: Schematic sectional view at B-B of an opening on port operating ring as shown in FIG. 5.

FIG. 7: Schematic sectional view at C-C of transfer passage on port operating ring as shown in FIG. 5.

FIG. 8: Schematic representation of a state when piston pairs have revolved little beyond TDC equivalent; CAV2 is ready for fuel ignition during its power stroke; CAV1 is undergoing its intake stroke. Exhaust flow passage is closed for CAV1.

FIG. 9: Schematic representation of a state of piston pairs, when transfer passage is about to open for CAV1 during its intake stroke, to commence flow of gases from pre-compression chamber to CAV1. CAV2 is continuing its power stroke.

FIG. 10: Schematic representation of a state when piston pairs at BDC equivalent; transfer passage is closed for CAV1; CAV2 is at the end of its power stroke.

FIG. 11: Schematic representation of a state when piston pairs have revolved little beyond BDC equivalent; intake to pre-compression chamber is about to open; compression phases of CAV1 and CAV2 are being utilised as compression stroke and exhaust stroke respectively; exhaust flow passage is open for CAV2.

FIG. 12: Schematic representation of a state when piston pairs have revolved little beyond TDC equivalent; CAV2 undergoing its intake stroke; intake to pre-compression chamber is about to close while CAV1 is ready for fuel ignition during its expansion phase.

FIG. 13: Schematic representation of a state of piston pairs, when transfer passage is about to open for CAV2 to start flow of gases from pre-compression chamber to CAV2; CAV1 is undergoing its power stroke.

FIG. 14: Schematic representation of a state when piston pairs at BDC equivalent; transfer passage is closed for CAV2; CAV1 is at the end of its power stroke.

FIG. 15: Schematic representation of a state when piston pairs have revolved little beyond BDC equivalent; intake to pre-compression chamber is about to open; compression phases of CAV2 and CAV1 are being utilised as compression stroke and exhaust stroke respectively; exhaust flow passage is open for CAV1.

### PRESENT REVOLVING PISTON DEVICE USED FOR EXPLANATION

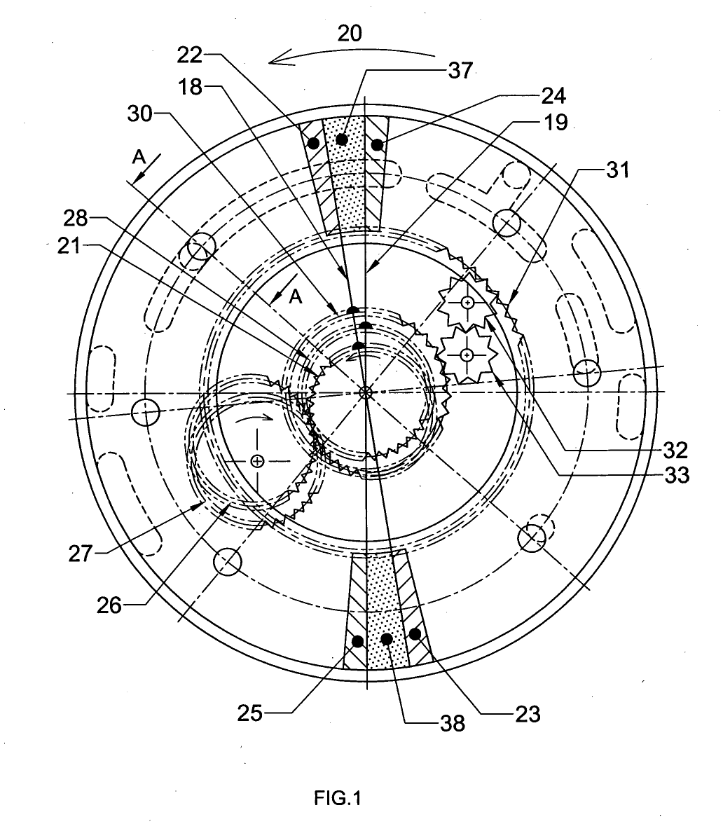

A revolving piston device with two revolving piston pairs associated with its fixed circular ring and with one port operating ring is considered here for explaining the functioning of multi-purpose openings on a component adjacent to revolving piston pairs i.e. on fixed circular ring for the present device, and corresponding openings on port operating ring. Each piston pair of the revolving piston device, gives one expansion phase and one compression phase for every revolution of its revolving pistons and the device is suitable for making a four stroke internal combustion engine. The revolving piston device is shown in FIG. 1, along with the speed profile generator that has two meshing elliptical gears coupled through appropriate gear train to respective revolving assemblies. Specific sealing arrangement that is needed for various openings and flow passages are not included at present.

Only a case, in which port operating ring is coupled through a positive drive train to a revolving assembly that has its portions working as leading revolving pistons, and openings on port operating ring revolve between openings on fixed circular ring and that for manifolds, is discussed for present explanation.

### Main Components of Revolving Piston Device:

Present revolving piston device as shown in FIG. 1 has following major components:

1. Main Assembly: This mainly includes one fixed circular ring, intake and exhaust manifolds, and two revolving assemblies consisting of two revolving piston pairs. Major components of main assembly are briefly described below:

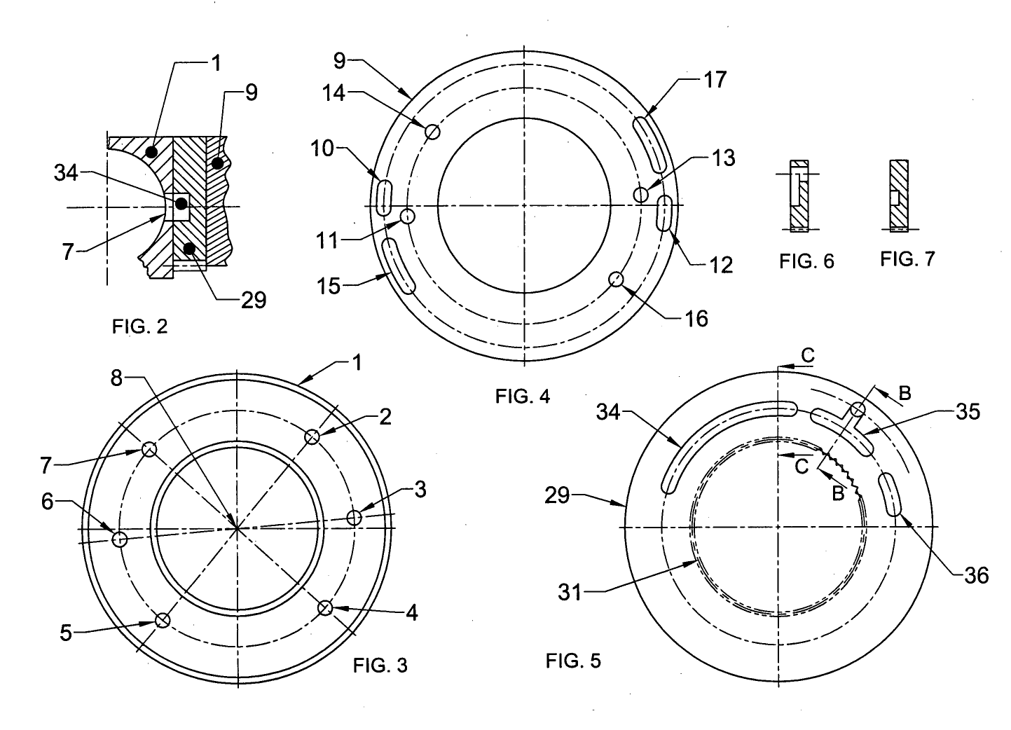

Fixed Circular Ring: This is a circular ring shaped fixed component with a suitable cross-section as represented by 1 in FIG. 2 and FIG. 3, and is provided with multi-purpose openings 2, 3, 4, 5, 6 and 7 that are used to facilitate flow of air or gases across the walls of fixed circular ring in respective direction as appropriately needed by different flow passages for operation of revolving piston device. An axis of fixed circular ring, that passes through centre 8 and is normal to the plane of paper of FIG. 3, is called common axis and is used as axis of revolution for many components of the revolving piston device. Fixed circular ring may also be called as fixed hollow ring cylinder and may be made of many parts joined together.

Intake and Exhaust Manifolds: The intake and exhaust manifolds are also fixed members and can be rigidly connected to fixed circular ring. Actual manifolds are not shown in the drawings but only schematic openings for intake and exhaust manifolds on a fixed member 9 are shown in FIG. 4. Openings 10, 11, 12 and 13 are for intake manifold and openings 14, 15, 16 and 17 are for exhaust manifold.

Revolving Assemblies: Present revolving piston device has two revolving assemblies that revolve in direction 20 around common axis, and are represented by 18 and 19 in FIG. 1. One of the revolving assemblies drives other revolving assembly with varying relative speed through positive drive train and through a mechanism called relative speed profile generator that governs their varying relative angular speed. For present case the positive drive train consists of a gear train. Each revolving assembly is attached with a ring gear with either internal or external teeth as to help transfer of motion without slip to relative speed profile generator. These ring gears belong to the positive drive train that transfers motion from one revolving assembly to the other revolving assembly. These ring gears can be replaced with chain wheels or timing pulleys or some other positive motion transfer devices that can appropriately be used for the same purpose. The present revolving piston device has revolving pistons and respective revolving member of relative speed profile generator revolve at same speed, thus one of the revolving assemblies, i.e. 18 does not have a ring gear instead it is directly and co-axially coupled to one of the revolving member i.e. elliptical gear 21 of relative speed profile generator. An output shaft can be suitably connected or suitably coupled to one of the revolving assemblies. Axis of the output shaft need not necessarily coincide with common axis. For present revolving piston device, the output shaft, not shown, is coaxially connected to revolving assembly 18 or elliptical gear 21.

Revolving Piston Pair: A portion of individual revolving assemblies 18 and 19, as discussed before is designed to act as revolving piston. Such two revolving pistons, one from each revolving assembly, form a revolving piston pair, one piston of which is called leading piston and other that follows the leading piston is called trailing piston. Present revolving piston device has two such revolving piston pairs. Two leading pistons and two trailing pistons are portions of revolving assemblies 18 and 19, and are represented by 22, 23 and 24, 25 respectively in FIG. 1.

2. Mechanism to control varying relative speed of the revolving assemblies: This mechanism governs the variation in relative rotational speed of one revolving assembly with respect to the other revolving assembly, that causes pistons of a revolving piston pair to revolve some times towards each other and some times away from each other to produce expansion and compression phases for CAV.

The mechanism consists of a relative speed profile generator together with a combination of positive drives, and is coupled to the revolving assemblies as to revolve both the revolving assemblies in same direction and as to give repeated cycles consisting of one expansion phase and one compression phase for CAV. The mechanism is not described here in details as it has been described in details in the two international patent applications mentioned before.

The revolving components of relative speed profile generator revolve around fixed axes. If one of the fixed axes coincides with common axis, and if the speed ratio of the revolving component of relative speed profile generator with respective revolving assembly is unity, then the revolving component can be rigidly coupled to the respective revolving assembly.

As shown in FIG. 1, present revolving piston device uses a relative speed profile generator that consists of two meshing elliptical gears 21 and 26, with their fixed axes of rotation passing through their respective focus points, and gives one expansion phase and one compression phase for every revolution of its revolving members i.e. the elliptical gears. Elliptical gear 21 is directly and coaxially connected to revolving assembly 18 and meshing elliptical gear 26 is rigidly and co-axially connected to a circular gear 27. Gear 27 is meshing with ring gear 28, which is coaxially fixed with revolving assembly 19 as to have gear ratio of 1:1 between 26 and 28 and to give same direction of revolution, for both the revolving assemblies. For present relative speed profile generator both the elliptical gears are selected to have identical pitch ellipses with ratio of major axis to minor axis as 42:40, by changing ratio of major axis to minor axis, relative speed profile can be changed.

A four bar linkage that works as a double crank mechanism with fixed crank axes can easily replace the relative speed profile generator consisting of two elliptical gears in mesh. Any other mechanism that can govern variation in relative speed of the two revolving assemblies can also be used as relative speed profile generator.

3. Mechanism to operate openings on fixed circular ring: For a revolving piston device which has no fixed zone on fixed circular ring to have an opening that can always be utilised for a particular flow passage whenever CAV is present within the zone, an additional mechanism is necessary for appropriately operating an opening on fixed circular ring. For example, in a revolving piston device that gives one cycle consisting of one expansion phase and one compression phase for every revolution of its revolving assemblies, an opening in a zone on fixed circular ring that can be opened for intake flow passage during one expansion phase of a CAV for its intake stroke must be kept closed during its next expansion phase, for its power stroke. Similarly an opening in a zone on fixed circular ring that can be opened for exhaust flow passage during a compression phase of a CAV for its exhaust stroke must be kept closed during its next compression phase, for its compression stroke.

For present revolving piston device, the additional mechanism that opens and closes an opening on fixed circular ring, is a ring like component, called port operating ring that revolves around common axis and controls flow of air or air fuel mixture or gases between manifolds, fixed circular ring and CAV. For present revolving piston device as shown in FIG. 1, a circular gear 30 is coaxially fixed to elliptical gear 21 and revolving assembly 18 and thus to leading pistons 22 and 23. A circular gear 31 with internal teeth is coaxially fixed to port operating ring 29 that is coaxially coupled to gear 30 through meshing gears 32 and 33 as to revolve port operating ring in direction 20 at half the speed of revolving assembly 18.

A typical port operating ring 29, schematically shown in FIG. 5 with sectional views at B-B and C-C shown in FIG. 6 and FIG. 7 respectively, is used with present revolving piston device to control flow of air or gases through openings 2, 3, 4, 5, 6 and 7 and appropriately direct flow of gases from intake manifold to pre-compression chamber, from pre-compression chamber to respective CAV and from respective CAV to exhaust manifold during revolutions of revolving piston pairs. An opening named as transfer passage 34 is used to direct flow of air or gases from pre-compression chamber to appropriate CAV. Multi-purpose openings 35 and 36 are used to appropriately direct flow of air or gases from intake manifold to pre-compression chamber and from CAV to exhaust manifold.

Principle of operation: If supply of a fluid is available through one fixed opening and is to be delivered to two different fixed openings than a movable passage or a movable opening can be designed as to select any of the two fixed openings to receive the fluid by appropriately moving the movable opening. Similarly instead of a movable opening, appropriate valves can be used to select any of the two fixed openings to receive the fluid.

Above principle is used to design openings on various components of the revolving piston device as to open and close different flow passages at different states as required for operating the device as an internal combustion engine.

For present device, port operating ring with multiple openings on it revolves between fixed openings on fixed circular ring and that for manifolds; the openings are designed in such a way as to create desired flow passage between respective fixed openings, as to govern flow of air or gases from CAV to exhaust manifold, from intake manifold to pre-compression chamber and from pre-compression chamber to respective CAV, for respective part of revolution of piston pair while port operating ring and piston pair continues to revolve.

For a case, in which port operating ring is revolving between revolving piston pair and openings on fixed circular ring, separate openings for manifolds may not be necessary as openings on fixed circular ring can act as that for manifolds as well, port operating ring is provided with multi purpose openings. Openings on port operating ring create flow passages from respective CAV to openings on fixed circular ring for exhaust manifold, from openings on fixed circular ring for intake manifold to pre-compression chamber and from pre-compression chamber to respective CAV, for respective part of revolution of piston pair while port operating ring and piston pair continue to revolve.

### Working of Revolving Piston Device as Internal Combustion Engine:

As mentioned above, in present revolving piston device, starting from their TDC equivalent, each piston pair gives one expansion phase and one compression phase for every revolution. To help understand working of the device as a four stroke engine, creation of few of the flow passages for air or gases are described below:

Flow passage from intake manifold to pre-compression chamber: While leading pistons 22 and 23 revolve slower than trailing pistons 24 and 25, the two CAV undergo compression phase that causes expansion of pre-compression chamber resulting in drop in pressure within it, which is utilised for suction of air or gases into it from intake manifold, by creating flow passage through openings 35 or 36 on port operating ring from at least one of the openings 10, 11, 12 and 13 for intake manifold to at least one opening on fixed circular ring, which is open to pre-compression chamber; this flow passage can be created when pressure of gases within pre-compression chamber drops adequately below the pressure of gases at the openings for intake manifold to avoid flow in reverse direction, and can remain open until piston pairs are near to TDC equivalent as to ensure maximum collection of air or gases in pre-compression chamber, typical flow passages of this type are shown in FIG. 11 and FIG. 15.

Flow passage from pre-compression chamber to CAV: When leading pistons 22 and 23 revolve faster than trailing pistons 24 and 25, the two CAV undergo expansion phase, which is utilised as power stroke for one CAV and as intake stroke for the other CAV; simultaneously contents of pre-compression chamber undergoes compression. Openings on port operating ring and that on fixed circular ring are designed in such a way that during this compression of pre-compression chamber, no flow passage is created through any opening on fixed circular ring that is open to the CAV undergoing its power stroke and through transfer passage 34, flow passage is created from at least one opening on fixed circular ring that is open to pre-compression chamber to at least one another opening on it that is open to the CAV undergoing its intake stroke, as to flow air or gases from pre-compression chamber to respective CAV; the flow passage to the CAV undergoing its intake stroke can be opened appropriately during expansion phase of the CAV when pressure within it is less than or equal to that in pre-compression chamber as to avoid flow reversal; the flow passage can be kept open until respective piston pair is near to its BDC equivalent as to fill the CAV with maximum quantity of air or gases. FIG. 9 and FIG. 13 show typical states of revolving piston device when flow passage from pre-compression chamber to respective CAV is about to open; FIG. 10 and FIG. 14 show a typical state when the flow passage closes.

Flow passage from CAV to exhaust manifold: Compression phase of CAV is utilised as exhaust stroke by a CAV and as compression stroke by the other CAV. Openings on port operating ring, fixed circular ring and that for manifolds are designed in such a way that during this compression phase of CAV, no flow passage is created through any opening on fixed circular ring that is open to the CAV undergoing its compression stroke and flow passage is created from at least one opening on fixed circular ring that is open to the CAV undergoing its exhaust stroke to at least one of the openings 14, 15, 16 and 17 for exhaust manifold, as to have flow of air or gases from the CAV to exhaust manifold; the flow passage should be created at the earliest after respective piston pair reaches its BDC equivalent as to release gases from the CAV immediately after completion of power stroke and the flow passage should close when the piston pair is near its TDC equivalent i.e. near end of exhaust stroke. FIG. 11 and FIG. 15 show typical states of the device when flow passages from respective CAV to exhaust manifold are open.

### Sequence of Operation:

37 and 38 represent CAV1 and CAV2 formed by revolving piston pairs 22, 24 and 23, 25 respectively. The spaces between pistons 22, 25 and 23, 24 are working as pre-compression chambers and are always inter-connected to work as single pre-compression chamber. For explaining sequence of operation, two cycles consisting one expansion phase and one compression phase each are considered that start from the state when piston pairs are at TDC equivalent as shown in FIG. 1.

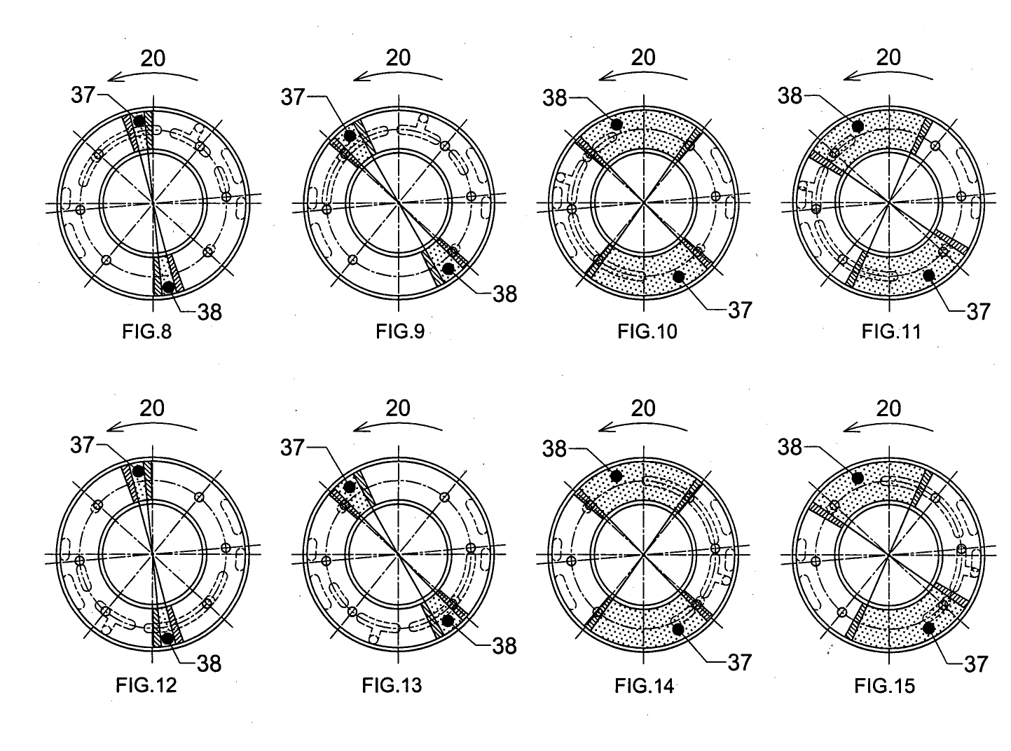

First expansion phase—TDC equivalent to BDC equivalent: As revolving assemblies and port operating ring revolve in direction 20, from TDC equivalent, pistons of a piston pair revolve away from each other and the CAV undergo expansion phase. Suitably after a little revolution from TDC equivalent, as shown in FIG. 8, fuel is ignited in CAV2 i.e. in 38 that increase pressure in CAV2 and thus power stroke begins for CAV2, during the stroke no flow passage is created for CAV2. After a suitable state as shown in FIG. 9, gases or air fuel mixture or air from pre-compression chamber start entering CAV1 i.e. 37, under pressure through flow passage created by 6, 34 and 7. While pistons revolve, as trailing piston 24 revolves past 7, flow of gases from pre-compression chamber to CAV1 stops for a while for absence of an opening within CAV1, soon after as opening 6 becomes open to CAV1, the flow of gases to CAV1 resumes through flow passage 7, 34, 6, as transfer passage 34 revolves past 7, the flow to CAV1 resumes through flow passage 5, 34, 6; later when 5 become open to CAV1, the flow of gases from pre-compression chamber to CAV1 continues through flow passage 6, 34, 5, until trailing piston 24 revolves beyond opening 5 and piston pair reach BDC equivalent as shown in FIG. 10. Thus from state of piston pairs as shown in FIG. 1 to that shown in FIG. 10, CAV1 i.e. 37 completes intake stroke and 38 i.e. CAV2 completes power stroke and the two CAV complete their first expansion phase.

First compression phase—BDC equivalent to TDC equivalent: As piston pairs revolve beyond their BDC equivalent state as shown in FIG. 11, pistons of a piston pairs revolve towards each other, flow passage opens through 7, 36 and 14, to flow gases from CAV2 to exhaust manifold; later as leading piston 23 revolves past 6, flow from CAV2 to exhaust manifold continues through flow passage created by 6, 35 and 15, the flow continues further through flow passage 5, 35, 15 until opening 35 revolves past 15, i.e. before piston pairs reach their TDC equivalent. During this compression phase, CAV2 i.e. 38 undergoes its exhaust stroke and CAV1 i.e. 37 undergoes compression stroke thus no flow passage is created for CAV1.

During this compression phase of CAV1 and CAV2 air or gases flow to pre-compression chamber from intake manifold through flow passage created by 10, 35 and 6; the flow stops when opening 35 revolves past 10 and the flow of air or gases resumes again through flow passage 11, 36, 6 until opening 36 revolves past 6 or 11, when piston pairs have revolved beyond TDC equivalent, as shown in FIG. 12.

Second expansion phase—TDC equivalent to BDC equivalent: As piston pairs revolve beyond TDC equivalent, as shown in FIG. 12, fuel is ignited within CAV1 to begin its power stroke and CAV2 i.e. 38 continues its intake stroke. In a way similar to that as described before for the flow of gases to CAV1, during intake stroke of CAV2, when piston pairs move beyond the state as shown in FIG. 13, flow of air or gases from pre-compression chamber to CAV2 i.e. to 38 begins through flow passage created by 3, 34 and 4, the flow stops for a while and resumes again through flow passage 4, 34, 3; later the flow continues through flow passage 2, 34, 3, then through flow passage 3, 34, 2 until piston pairs reach their BDC equivalent as shown in FIG. 14. CAV1 and CAV2 complete their respective strokes, during this expansion phase no flow passage is created for CAV1.

Second compression phase—BDC equivalent to TDC equivalent: As piston pairs revolve further beyond their BDC equivalent, as shown in FIG. 15, CAV1 begins its exhaust stroke and gases flow from CAV1 to exhaust manifold through flow passage created by 4, 36 and 16, later the flow continues through flow passage 3, 35, 17; then through flow passage 2, 35, 17, until 35 revolves past 17. No flow passage is created for CAV2 as it continues its compression stroke. During this compression phase also air or gases flow from intake manifold to pre-compression chamber through flow passage created by 12, 35 and 3 that continues through flow passage 13, 36, 3 until 36 revolves past 3. As piston pairs reach their TDC equivalent, CAV1 and CAV2 complete their respective strokes and revolving piston device attains the state as in FIG. 1.

Thus in two revolutions of the pistons each piston pair complete two cycles of one expansion and one compression each. Piston pair 22, 24 i.e. CAV1 utilises first expansion phase for its intake stroke while other piston pair 23, 25 i.e. CAV2 utilises the same as its power stroke. Subsequently first compression phase is utilised by CAV1 for its compression stroke and by CAV2 for its exhaust stroke. Second expansion phase is utilised by CAV1 for its power stroke and by CAV2 for its intake stroke. The second compression phase is utilised by CAV1 for its exhaust stroke and by CAV2 for its compression stroke. These two cycles continue to repeat as these piston pairs keep revolving. The fuel is ignited appropriately in respective CAV near the beginning of their respective expansion phase.

It can be seen that same openings 2, 3, 4, 5, 6, and 7 on fixed circular ring, and openings 35 and 36 on port operating ring are used for flow passages of gases from intake manifold to pre-compression chamber and also for flow passages of gases from respective CAV to exhaust manifold for different parts of revolutions. Openings 2 to 7 on fixed circular ring are also used for flow passage from pre-compression chamber to respective CAV. It can also be seen that the direction of flow of gases through the openings is changing from time to time. Mechanical power can be delivered by the output shaft. An appropriate flywheel may have to be coupled to a suitable revolving assembly.

### Alternative Design Arrangements for Revolving Piston Device:

In present revolving piston device, few intermittent flows of air or gases are used during respective expansion and compression phases, in a revolving piston device the flows can be designed to be continuous with appropriate design of openings on various components of the device. Actual size and number of openings on individual components can be different from the one described here. It is important to note that fixed circular ring, respective manifolds, revolving assemblies, and port operating ring all are to be specifically designed with suitable openings so that opening and closing of respective flow passages is appropriately synchronized with respective revolution of respective revolving piston pair.

Different alternative design arrangements for revolving piston devices are listed below, for individual alternative design arrangements, openings on various components are to be designed accordingly.
1. For present revolving piston device, every revolving piston pair gives one expansion phase and one compression phase for its every revolution; it is possible to make a revolving piston device in which every revolving piston pair revolves for less than one or more than one revolution to give one expansion phase and one compression phase.
2. Instead of two revolving piston pairs, one or more revolving piston pairs associated with one fixed circular ring can be used.
3. Instead of having all openings on fixed circular ring working as common openings for all flow passages at different times, openings on fixed circular ring can have any combination of common openings, special purpose openings that are used only for some particular flow passage and multi-purpose openings that are used for more than one flow passages at different times. Simultaneous opening and closing of multiple openings can also be designed for a flow passage to have better control on flow of air or gases.
4. Instead of six identical common openings on fixed circular ring, individual openings on fixed circular ring can be designed to have different shape and size, total number of openings on fixed circular ring can also be other than six.
5. Instead of having openings on port operating ring revolve between openings on fixed circular ring and that for manifolds, a port operating ring can be designed as to have openings on it revolve between revolving pistons and openings on fixed circular ring, thus port operating ring becomes the component adjacent to revolving piston pair and in such case multi purpose openings are to be provided on port operating ring; openings on fixed circular ring may not be multi purpose openings and can also work as openings for manifolds.
6. Instead of coupling port operating ring to a revolving assembly that has its portions working as leading pistons with a speed ratio of 1:2, an appropriately designed port operating ring can be coupled to any other revolving component of revolving piston device and can have speed ratio other than 1:2 with an appropriate revolving assembly.
7. Instead of single port operating ring, multiple port operating rings can be used, in that case individual port operating ring can be coupled to different revolving members of revolving piston device and may have different speed ratio with respective revolving assemblies.
8. Present port operating ring can be replaced with suitable valves for appropriate closing and opening of various flow passages for flow of air or gases.
9. Instead of port operating ring, a combination of valves and port operating ring can be used for appropriate closing and opening of various flow passages of air or gases. An appropriately designed valve for closing and opening of an opening on fixed circular ring can further reduce unutilised opening as the member of valve that enters the opening and the respective opening together can be designed as to reduce the unutilised volume of the opening. Proper use of valves can also eliminate the need of port operating ring and thus can also eliminate the need of separate openings for manifolds as the openings on fixed circular ring can themselves act as openings for respective manifolds
10. Instead of aligning the output shaft with the common axis and coupling it to the revolving assembly that has its portions working as leading pistons, axis of output shaft can be made independent of common axis and output shaft can be coupled to any other revolving member of revolving piston device.
11. In a spark ignition engine, a spark plug can be mounted on a revolving piston of a piston pair or on a revolving assembly; this makes it easy to change the timing of ignition of fuel, by shifting the timing for spark generation with respect to the position of a revolving piston, during the power stroke of respective CAV. This also reduces the unutilised space as the space used by the spark plus always remains within CAV and no piston passes over the position of spark plug. This also simplifies sealing requirements for revolving pistons.
12. By changing the ratio of major axis to minor axis of the two meshing elliptical gears, different relative speed profiles can be obtained.
13. Instead of two meshing elliptical gears, a four bar linkage that works as a double crank mechanism can also be used for relative speed profile generator, in that case two fixed axes of rotation of elliptical gears are to be replaced with two fixed axes of rotation of the two cranks. The relative speed profile generated by double crank mechanism may be different than that generated by two meshing elliptical gears, various components of revolving piston device and openings on individual components are to be designed accordingly. Directions of rotations of respective cranks may be different from that of respective elliptical gears; positive drive train may also need to be modified accordingly as to give same direction of revolution for the two revolving assemblies.

Compressed air engine OR external combustion engine: Revolving piston device that has been described before can also be used to make an engine that converts energy of compressed air or high pressure gases into mechanical power with suitable design of various components of revolving piston device, the engine thus made can be called as compressed air engine or an external combustion engine. These types of engines require only one expansion phase and one compression phase to complete one cycle of its operation. For this application, high pressure gases, obtained as products of combustion by burning fuel in a specially designed combustion chamber outside fixed circular ring, or as compressed air, is supplied, as intake to CAV. Sequence of operation of such an engine is described below:

A flow passage is created for compressed air or products of combustion to flow from openings for intake manifold to respective CAV at the beginning of its expansion phase. The flow of compressed air or gases is either continued to respective CAV through-out the expansion phase or is continued to flow to respective CAV for a portion of its expansion phase and then allowed to expand within the CAV for rest of the expansion phase, by creating suitable flow passage from openings for intake manifold, which, for this application supplies compressed air or products of combustion, to respective CAV for respective revolution of respective revolving piston pair. The expansion of these gases forces the pistons of respective piston pair to move away from each other and thus revolve revolving assemblies to produce mechanical power which is made available at the output shaft. Here it is to be noted that expansion phase of CAV is utilised as power stroke. The compression phase of respective CAV is utilised as its exhaust stroke by creating flow passage from respective CAV to openings for exhaust manifold for maximum duration during the compression phase. For this purpose, a revolving piston device that gives one cycle consisting of one expansion phase and one compression phase for every revolution of each revolving piston pair, can also be designed to work without a port operating ring.

Advantages of multi-purpose openings in a Revolving Piston Device: All the advantages of a revolving piston device that are mentioned in the patent applications PCT/IN03/00025 and PCT/IN06/00321 are equally applicable here; additional main advantages of revolving piston device with multi-purpose openings provided on fixed circular ring and on port operating ring are listed below:
1. Total exposure of openings within a CAV is reduced, thus quantity of unutilised gases is reduced, which increases overall efficiency of the revolving piston device. For example, consider a four stroke internal combustion engine as described before, gases trapped within an opening that exists within pre-compression chamber can enter a CAV during its power stroke when the opening comes within respective CAV, can also enter a CAV during its exhaust stroke and may get escaped un-burnt to exhaust manifold, resulting in wastage of fuel that is reduced by reducing the exposure of an opening within CAV. Similarly it reduces gases trapped within an opening during intake stroke and compression stroke of respective CAV may get released to pre-compression chamber when the opening comes within pre-compression chamber resulting in lower intake quantity of fresh air or gases to pre-compression chamber and loss of energy supplied to the unused trapped gases during compression stroke, respectively.
2. With use of multi-purpose or common openings on fixed circular ring, size of port operating ring can be reduced, which helps in reducing revolving mass.
3. With multi-purpose or common openings on fixed circular ring, additional openings can be designed on fixed circular ring for increased flow for any particular flow passage accordingly either the port operating ring is to be modified or an additional port operating ring is to be designed or additional valves need to be used for control of flow through the additional openings.
4. With appropriate design of multi-purpose openings on fixed circular ring, corresponding openings on port operating ring and that for manifolds, it is possible to change compression ratio of the revolving piston device, by changing the clearance volume i.e. by changing minimum CAV possible, that can be done by changing the clearance angle between the pistons of revolving piston pairs when at TDC equivalent, to make a multi-fuel engine or a variable compression ratio engine. It is necessary to design fuel ignition system and fuel intake system to suit the purpose. Multi-fuel engine thus made can be made to switch over from one fuel to another fuel in a very short time.
5. This device is suitable for making engine for all types of fuels and different ignition methods those can be used in reciprocating piston engines. The combustion chamber can also be designed outside the fixed circular ring.
6. Use of more revolving piston pairs associated with one fixed circular ring can allow higher power generation for approximately same physical size of the engine. Thus higher power to weight ratio is obtainable with less modification.
7. The engine thus made can be used as an engine module that can be put together in parallel with a common output shaft to increase power output.
8. Multiple engines can be used at a time with a common output shaft to make an equivalent of multi-cylinder reciprocating piston engine. Engine or part of engine can be designed for interchangeability and thus making it possible to keep it as a spare and use it to replace a faulty one with ease and with minimum down time in emergency. It is possible to change power output by engaging or disengaging a particular engine from the common output shaft.
9. While using multiple engines, different engines can be arranged with a common output shaft in such a way that power strokes in different engines do not occur simultaneously, for obtaining smooth power output and possibly for reducing the size of flywheel.
10. A two stroke internal combustion engine can be made with revolving piston device by suitably utilising the revolution of the piston pair from BDC to TDC, for exhaust, intake, and then for compression processes and utilising the revolution of piston pair from TDC to BDC for power stroke.

### Disadvantages of Multi-Purpose Openings in a Revolving Piston Device:

As same opening on a fixed circular ring or same opening on port operating ring is used for multiple flow passages, some amount of gases trapped within an opening from one flow passage may get mixed with gases from other flow passage when the opening becomes a part of the other flow passage.

1. A revolving piston device, comprising at least one fixed circular ring, in which at least one piston pair revolves around an axis of the fixed circular ring; wherein one piston of the piston pair is a portion of and connected to a first revolving assembly and the other piston of the piston pair is a portion of and connected to a second revolving assembly, the space between the two pistons of the piston pair acts as controlled active volume; wherein the two revolving assemblies and thus the pistons connected to it, revolve with varying relative speed; wherein this variation in relative speed between the two pistons of a piston pair causes expansion and compression of the controlled active volume as one of the revolving assemblies is some times slower and some times faster than the other revolving assembly; wherein one of the two revolving assemblies drives the other through positive drive that includes a linkage that is mounted on fixed axes and governs the variation in relative speed of one revolving assembly with respect to the other and revolve both the revolving assemblies in same direction, and wherein an output shaft is connected to one of the two revolving assemblies; characterised in that at least one of the openings provided on any component of the revolving piston device is used for one flow passage for some time and for some other flow passage for some other time during revolutions of revolving piston pair.

2. A revolving piston device as in claim 1 that has more than one revolving piston pairs associated with one fixed circular ring and at least two spaces trapped between pistons of different revolving piston pairs are connected by a passage as to have free flow of air or gases between them.

3. A revolving piston device as in claims 1 and 2 that has at least one component revolve around the axis of fixed circular ring and is coupled to one of the revolving members of the revolving piston device; the component has at least one opening on it as to allow the flow of air or gases through it and through at least one opening on a component of the revolving piston device for some time during revolutions of revolving piston pair.

4. A revolving piston device as in claims 1 and 2, that uses at least one valve for controlling flow of air or gases through an opening or a passage provided on a component of the revolving piston device.

5. A revolving piston device as in claims 1 to 4 that has air or gases flow from intake manifold to pre-compression chamber during a compression phase of a controlled active volume and during its next expansion phase, air or gases flow from pre-compression chamber to at least one controlled active volume.

6. A revolving piston device as claimed in claims 1 to 5 that is used as a variable compression ratio device by providing a facility to change the volume of controlled active volume when revolving piston pair is at its TDC equivalent, by changing separation between pistons of the revolving piston pair.

7. A revolving piston device as in claims 1 to 6, which has more than one revolving piston pairs and the flow of air or gases is arranged in such a way that when one controlled active volume experiences first cycle of expansion and compression phases, some other controlled active volume experiences second cycle of expansion and compression phases during every two cycles of one expansion phase and one compression phase each.

8. A revolving piston device as in claims 1 to 7 that is used to make a spark ignition internal combustion engine and has a spark plug mounted either on at least one revolving piston or mounted on a revolving assembly.

9. A revolving piston device as in claims 1 to 7 that is used to make an internal combustion engine by sequentially utilising an expansion phase of a controlled active volume as intake stroke, following compression phase as compression stroke, then next expansion phase as power stroke by igniting fuel in the controlled active volume near the start of second expansion phase and following compression phase as exhaust stroke, during two cycles of one expansion phase and one compression phase each.

10. A revolving piston device as in claims 1, 3, 4 and 6 that is used to make an external combustion engine or a compressed air engine by using part of expansion phase of a CAV or complete expansion phase of a CAV as intake stroke for supply of products of combustions or compressed air respectively, to the CAV and using following compression phase as exhaust stroke.

11. An engine arrangement comprising of two or more engines, as claimed in claims 8, 9 and 10, coupled to a common output shaft.

12. An engine arrangement according to claim 11, wherein the engines are arranged in such a way that power strokes in all engines does not start simultaneously.

13. An engine arrangement according to claims 11 and 12, wherein the individual engines or part of engines, are provided as separate modules and engine fittings are designed for interchangeability to allow use of a single separate module as a spare for replacement of a faulty module out of the engine arrangement.

14. An engine arrangement according to claims 11 to 13 in which at least one engine can be connected to or disconnected from the common output shaft.

15. A revolving piston device according to any of the claims 1 to 6, that is used to form a revolving piston compressor by using expansion phase of the controlled active volume for intake of air and following compression phase for supplying the compressed air to a reservoir appropriately near the end of compression phase; the output shaft is used as input shaft to supply mechanical power to one of the revolving assemblies as input to the compressor.
